(19) United States
(12) Patent Application Publication
(10) Pub. No.: US 2020/0295819 A1
(43) Pub. Date: Sep. 17, 2020

(54) WIRELESS VIDEO BRIDGE FOR REMOVING ELECTROMAGNETIC RADIATION NOISE, AND SYSTEM COMPRISING SAME

(71) Applicant: EMW CO., LTD., Incheon (KR)

(72) Inventors: Won Mo SEONG, Gyeonggi-do (KR); Sang Man OH, Seoul (KR)

(21) Appl. No.: 16/085,650

(22) PCT Filed: Mar. 15, 2017
(86) PCT No.: PCT/KR2017/002790

§ 371 Date: Sep. 17, 2018

(30) Foreign Application Priority Data
Mar. 16, 2016 (KR) 10-2016-0031424

(51) Int. Cl. H04B 7/155; H04B 1/59; G08B 13/196

(52) U.S. Cl. CPC H04B 7/15585; G08B 13/1966; H04B 1/59; H04B 7/15571

(57) ABSTRACT

A wireless video bridge for removing electromagnetic radiation noise includes an interface and a shielding part configured to remove a harmonic signal generated in relation to the interface when the wireless video bridge is operating. The wireless video bridge may provide a technology capable of guaranteeing continuity of surveillance by increasing a data transmission rate when transmitting an image captured by a security camera

### TECHNICAL FIELD

The present invention relates to a wireless video bridge for removing electromagnetic radiation noise.

### BACKGROUND ART

Recently, installation of security cameras is increasing because of crime prevention, surveillance, information gathering, or the like. Conventionally, although an image captured by a security camera is transmitted through a wired network, there is an attempt to transmit the image through a wireless communication network such as wireless fidelity (Wi-Fi) or long-term evolution (LTE) due to a difficulty in wiring and an increase in installation cost.

The conventional Wi-Fi, which is single input single output (SISO)-based wireless communication and in which a disconnection phenomenon of data transmission occurs due to multi pass fading according to delay of a reception signal caused by a surrounding environment such as obstacles, responds with a method of increasing a data compression rate when a data transmission rate decreases due to various wireless communication environment variables, and thus degradation of a high resolution image occurs.

In addition, although a patch antenna with a high output is used for remote transmission, there are problems in that an installation cost of the patch antenna increases, and the patch antenna is difficult to install because a position and a direction of the patch antenna have to be considered, and cannot be applied to a remote transmission in an interior because an antenna with a high output such as the patch antenna has to be applied to only an exterior.

LTE is a wireless image transmission method which is a big burden to both a provider and a consumer because there is a limitation in that a service has to be provided through a designated network operator, a cost of system building for a related service is expensive, and a user who receives the service has to pay for using LTE data.

In addition, an electromagnetic interference (EMI) property needs to be improved to improve transmission performance of an image captured by a security camera.

### DISCLOSURE

### Technical Problem

The present invention is directed to providing a technology capable of increasing a data transmission rate to guarantee continuity of surveillance when an image captured by a security camera is transmitted.

In addition, the present invention is directed to providing a technology capable of remotely transmitting an image captured by a security camera installed at an exterior and an interior.

In addition, the present invention is directed to providing a technology configured to remove a harmonic signal which is electromagnetic radiation noise caused by a radiation point.

### Technical Solution

One aspect of the present invention provides a wireless video bridge including an interface, and a shielding part configured to remove a harmonic signal generated in relation to the interface when the wireless video bridge is operating.

The shielding part may include at least one from among a bead, a resistor, and a capacitor, the interface may include a local area network (LAN) port configured to communicate with an external device outside the wireless video bridge, and the shielding part may include a first shielding part configured to remove a harmonic signal generated by a data transmission line positioned between the LAN port and a controller of the wireless video bridge for data transmission.

The interface may further include a switch port configured to communicate with a switch board of the wireless video bridge, and the shielding part may further include a second shielding part configured to remove a harmonic signal generated by a connecting cable which connects the switch port and the switch board.

### DESCRIPTION OF DRAWINGS

FIG. 1A is a front view illustrating a wireless video bridge according to one embodiment.

FIG. 1B is a side view illustrating the wireless video bridge according to one embodiment.

FIG. 2 is a schematic configuration view illustrating the wireless video bridge according to one embodiment.

FIG. 3 is a schematic block diagram illustrating a security camera system according to one embodiment.

FIG. 4 is a schematic block diagram illustrating the security camera illustrated in FIG. 3.

FIG. 5 is a view for describing a beamforming operation between a first wireless video bridge and a second wireless video bridge illustrated in FIG. 3.

### MODES OF THE INVENTION

In embodiments according to the concept of the present invention disclosed in the specification, specific structural and functional descriptions are directed only to providing examples for describing the embodiments of the present invention, and the embodiments according to the concept of the present invention may be implemented in various forms, and the present invention is not limited to the embodiments described in the specification.

While the embodiments according to the concept of the present invention may be modified in various ways and have various alternative forms, examples of the embodiments are shown in the drawings and described in detail below. There is no intent to limit the present invention to the particular forms disclosed. On the contrary, the present invention covers all modifications, equivalents, and alternatives falling within the spirit and scope of the present invention.

It should be understood that, although the terms first, second, and the like may be used herein in reference to elements of the present invention, such elements are not to be construed as limited by the terms. The terms are only used to distinguish one element from another. For example, a first element could be termed a second element, and a second element could be termed a first element without departing from the scope of the present invention.

It should be understood that, when an element is referred to as being “connected” or “coupled” to another element, the element may be directly connected or coupled to the other element, or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” and the like).

The terminology used herein to describe the embodiments of the present invention is not intended to limit the scope of the present invention. The articles “a,” “an,” and “the” are singular in that they have a single referent, however the use of the singular form in the present document does not preclude the presence of more than one referent. In other words, elements of the present invention referred to in the singular may number one or more unless the context clearly indicates otherwise. It should be further understood that the terms “comprise,” “comprising,” “include,” and/or “including,” when used herein, specify the presence of stated features, numbers, steps, operations, elements, and/or components, but do not preclude the presence or addition of one or more other features, numbers, steps, operations, elements, components, and/or groups thereof.

Unless otherwise defined, all terms (including technical and scientific terms) used herein should be interpreted as is customary in the art to which the present invention belongs. It should be further understood that terms in common usage should also be interpreted as is customary in the relevant art and not in an idealized or overly formal sense unless expressly so defined herein.

Hereinafter, the embodiments will be described in detail with reference to the accompanying drawings. However, the scope of the present invention is not limited to the embodiments. The same reference numerals in the drawings refer to the same members.

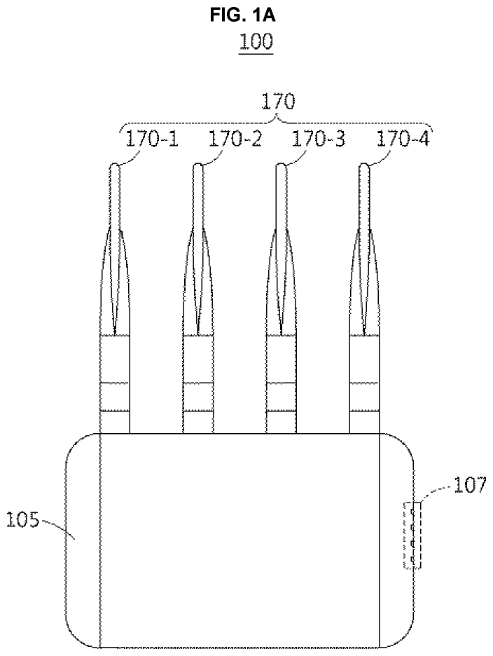

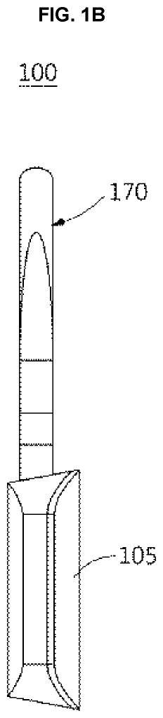

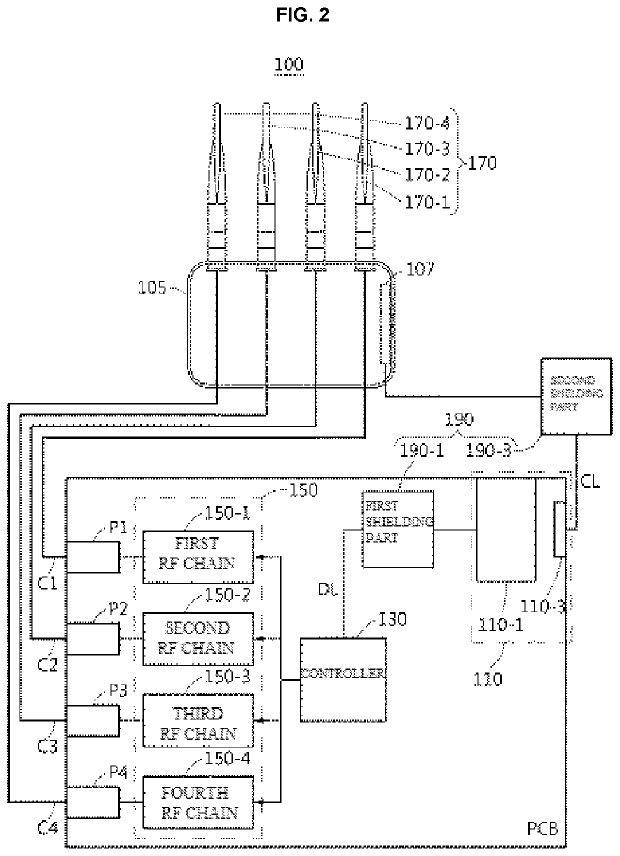

FIG. 1A is a front view illustrating a wireless video bridge according to one embodiment, FIG. 1B is a side view illustrating the wireless video bridge according to one embodiment, and FIG. 2 is a schematic configuration view illustrating the wireless video bridge according to one embodiment.

Referring to FIGS. 1A to 2, a wireless video bridge 100 may transmit/receive image data. The image data may be image data generated by a security camera (not shown).

The wireless video bridge 100 may be a communication device for transmitting/receiving the image data generated by the security camera. For example, the wireless video bridge 100 may transmit/receive the image data using the IEEE 802.11ac standard.

In a case in which the wireless video bridge 100 transmits the image data, the wireless video bridge 100 may be connected to the security camera, receive the image data generated by the security camera, and transmit the image data to an external receiving device. In a case in which the wireless video bridge 100 receives the image data, the wireless video bridge 100 may be connected to a storage device and transmit the image data to the storage device.

The wireless video bridge 100 may include a plurality of antennas 170-1 to 170-4 for a multi input multi output (MIMO) function to increase a transmission rate or a transmission amount of image data. In addition, the wireless video bridge 100 may serve a beamforming function for remote image data transmission.

Hereinafter, for the sake of convenience in the description, an operation of the wireless video bridge 100 will be described using an example case in which the wireless video bridge 100 is connected to the security camera and transmits the image data generated by the security camera to the external receiving device.

The wireless video bridge 100 may include an interface 110, a controller 130, a radio frequency (RF) chain part 150, an antenna part 170, and a shielding part 190.

The interface 110 may include a local area network (LAN) port 110-1 for communicating with the security camera. The LAN port 110-1 and the security camera may be connected through a LAN cable.

Accordingly, the LAN port 110-1 may receive the image data transmitted from the security camera.

Here, the image data may be compressed image data. The LAN port 110-1 may be an interface for Ethernet communication between the security camera and the wireless video bridge 100.

Image data received through the LAN port 110-1 may be transmitted to the controller 130 through one or more data transmission lines DL positioned between the LAN port 110-1 and the controller 130 for data transmission.

In addition, the interface 110 may further include a switch port 110-3 for communicating with a switch board 107. The switch port 110-3 may be connected to the switch board 107 through a connecting cable CL. Therefore, the switch board 107 may be connected to a printed circuit board (PCB).

The controller 130 may control the overall operation of the wireless video bridge 100.

The controller 130 may modulate the image data. For example, the controller 130 may modulate the image data through a 256-quadrature amplitude modulation (QAM) method. That is, the controller 130 may control an amplitude and a phase of the image data using an in-phase carrier wave and a quadrature carrier wave to generate a plurality of subcarriers. The number of subcarriers may correspond to the number of plurality of RF chains 150-1 to 150-4 included in the RF chain part 150 and the number of plurality of antennas 170-1 to 170-4 included in the antenna part 170. A modulation method of the controller 130 is not limited to the 256-QAM method.

The controller 130 may assign the plurality of subcarriers to the RF chain part 150 and transmit the plurality of subcarriers through the antenna part 170. Here, the controller 130 may control the RF chain part 150 to perform beamforming through the antenna part 170.

The RF chain part 150 may include the plurality of RF chains 150-1 to 150-4. The plurality of RF chains 150-1 to 150-4 may receive the assigned subcarriers, and amplify the subcarriers.

The antenna part 170 may include the plurality of antennas 170-1 to 170-4. The plurality of antennas 170-1 to 170-4 may transmit the subcarriers transmitted from the corresponding plurality of RF chains 150-1 to 150-4 to the external receiving device.

The plurality of antennas 170-1 to 170-4 may be connected to the corresponding plurality of RF chains 150-1 to 150-4 through corresponding antenna ports P1 to P4 and antenna cables C1 to C4. That is, the plurality of RF chains 150-1 to 150-4 and the plurality of antennas 170-1 to 170-4 may form one transmission path for subcarrier transmission.

For example, the first antenna 170-1 may be electrically connected to the first RF chain 150-1 through the first antenna port P1 and the first antenna cable C1. The second antenna 170-2 may be electrically connected to the second RF chain 150-2 through the second antenna port P2 and the second antenna cable C2. The third antenna 170-3 may be electrically connected to the third RF chain 150-3 through the third antenna port P3 and the third antenna cable C3. The fourth antenna 170-4 may be electrically connected to the fourth RF chain 150-4 through the fourth antenna port P4 and the fourth antenna cable C4.

Here, in FIGS. 1A to 2, each of the numbers of plurality of RF chains 150-1 to 150-4 and plurality of antennas 170-1 to 170-4 is four, but is not limited thereto, and may be various numbers.

The shielding part 190 may remove (or block) noise, that is, a harmonic signal, generated by the wireless video bridge 100 when the wireless video bridge 100 is operating. For example, the harmonic signal may be a harmonic signal generated in relation to (or caused by) the interface 110 positioned on the PCB.

The shielding part 190 may include a first shielding part 190-1 configured to remove harmonic signals generated by one or more data transmission lines DL positioned between the LAN port 110-1 and the controller 130 for data transmission.

For example, the first shielding part 190-1 may include at least one from among a bead, a resistor, and a capacitor. That is, the first shielding part 190-1 may be formed using at least one from among the bead, the resistor, and the capacitor. Here, the first shielding part 190-1 may be formed for each of the data transmission lines DL.

In addition, the shielding part 190 may further include a second shielding part 190-3 configured to shield harmonic signals generated by one or more connecting cables CL for connecting the switch port 110-3 and the switch board 107.

For example, the second shielding part 190-3 may include at least one from among a bead, a resistor, and a capacitor. That is, second shielding part 190-3 may be formed using at least one from among the bead, the resistor, and the capacitor. Here, the second shielding part 190-3 may be formed for each of the data transmission lines DL.

Since the first shielding part 190-1 and the second shielding part 190-3 are disposed at radiation points for removing the harmonic signals generated by the LAN port 110-1 and the switch port 110-3 which are the radiation points when the wireless video bridge 100 is operating, the harmonic signals, which are electromagnetic radiation noise, are removed so that an electromagnetic interference (EMI) property of the wireless video bridge 100 can be improved.

Operations of the components of the wireless video bridge 100 have been described using the example case in which the wireless video bridge 100 is connected to the security camera and transmits the image data generated by the security camera to the external receiving device for the sake of convenience in the description, but are not limited thereto. For example, the wireless video bridge 100 may receive a signal transmitted from the external receiving device through the RF chains 150-1 to 150-4 and the antennas 170-1 to 170-4.

Here, the RF chains 150-1 to 150-4 may filter a signal of a using frequency band out of received signal radio waves, amplify the filtered signal, and transmit the amplified and filtered signal to the controller 130.

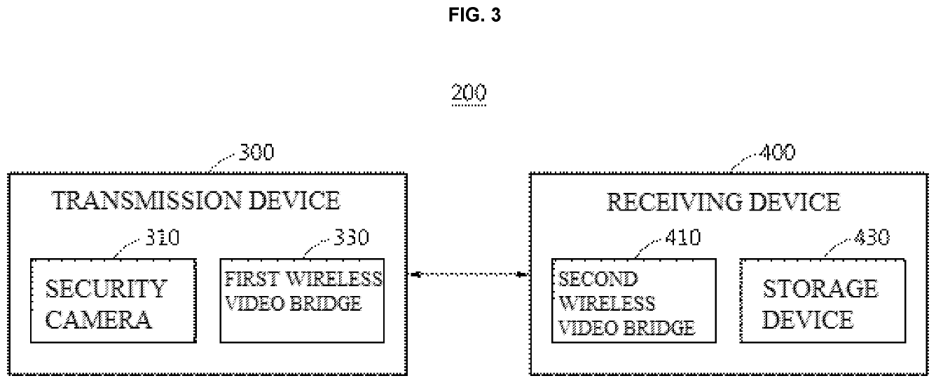

FIG. 3 is a schematic block diagram illustrating a security camera system according to one embodiment.

Referring to FIG. 3, a security camera system 200 may include a transmission device 300 and a receiving device 400.

The transmission device 300 and the receiving device 400 may communicate through a plurality of channels. Here, wireless LAN, Wi-Fi, mobile communication networks, ZigBee, Bluetooth, and the like may be used. Wi-Fi may be the IEEE 802.11ac standard.

The transmission device 300 may include a security camera 310 and a first wireless video bridge 330. The receiving device 400 may include a second wireless video bridge 410 and a storage device 430. Components and operations of each of the wireless video bridges 330 and 410 illustrated in FIG. 3 may be the same as those of the wireless video bridge 100 described with reference to FIGS. 1A to 2.

The security camera 310 may be installed at a predetermined position (exterior or interior), and may surveil a region from the position at which the security camera 310 is installed. The security camera 310 may control pan/tilt and the like to secure a shooting angle and a shooting view. The security camera 310 may be an internet protocol (IP) camera or closed circuit television (CCTV) camera.

The security camera 310 may capture an image of the region at which the security camera 310 is installed and generate image data. The security camera 310 may transmit the captured image to the first wireless video bridge 330. For example, the security camera 310 may compress the image data, and transmit the compressed image data to the first wireless video bridge 330.

The security camera 310 and the first wireless video bridge 330 may be communicably connected through LAN such as Ethernet. As an example, the first wireless video bridge 330 may be separated from the security camera 310, and installed (or positioned) outside the security camera 310. As another example, the first wireless video bridge 330 may be integrally formed with the security camera 310. The first wireless video bridge 330 may be built in the security camera 310. That is, the first wireless video bridge 330 may be embedded in the security camera 310.

The first wireless video bridge 330 may transmit image data transmitted from the security camera 310 to the receiving device 400 through beamforming. Specifically, the first wireless video bridge 330 may perform pairing with the second wireless video bridge 410 and may be communicably connected to the second wireless video bridge 410 through a plurality of RF chains and a plurality of antennas included in the first wireless video bridge 330. In this process, the first wireless video bridge 330 may determine a direction of the second wireless video bridge 410 with respect to the first wireless video bridge 330. Next, the first wireless video bridge 330 may shift phases of subcarriers assigned to the plurality of RF chains such that a direction in which points at which beam patterns transmitted from the plurality of antennas commonly intersect are connected is toward the second wireless video bridge 410. In addition, the first wireless video bridge 330 may amplify amplitudes of the beam patterns transmitted from the plurality of antennas.

The second wireless video bridge 410 may receive the image data transmitted from the first wireless video bridge 330. For example, the second wireless video bridge 410 may receive the image data using the IEEE 802.11ac standard.

In addition, the second wireless video bridge 410 may perform bidirectional communication with the first wireless video bridge 330. The second wireless video bridge 410 may transmit a signal associated with the transmission device 300 to the transmission device 300. The signal associated with the transmission device 300 may include a signal (or data) for the transmission device 300, for example, at least one of the security camera 310 and the first wireless video bridge 330, or a control signal for controlling the at least one of the security camera 310 and the first wireless video bridge 330.

The second wireless video bridge 410 may transmit the image data transmitted from the transmission device 300 to the storage device 430. Here, the storage device 430 and the second wireless video bridge 410 may be communicably connected through LAN such as Ethernet. As an example, the second wireless video bridge 410 may be separated from the storage device 430 and formed (positioned) outside the storage device 430. As another example, the second wireless video bridge 410 may be integrally formed with the storage device 430. The second wireless video bridge 410 may be built in the storage device 430.

That is, the second wireless video bridge 410 may be embedded in the storage device 430.

The storage device 430 may store the image data transmitted from the transmission device 300. The storage device 430 may include a local storage such as a direct attached storage (DAS), a network storage such as a network attached storage (NAS) or storage area network (SAN), a cloud storage, and other various storages. For example, the storage device 430 may be a network video recorder (NVR), a digital video recorder (DVR), or the like.

The storage device 430 may be connected to a display device (not shown) formed outside the receiving device 400. The image data stored in the storage device 430 may be displayed through the display device.

The display device may be formed as a personal computer (PC), a data server, or a portable device. The portable device may be formed as a laptop, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, or a smart device. For example, the smart device may be formed as a smart watch or smart band.

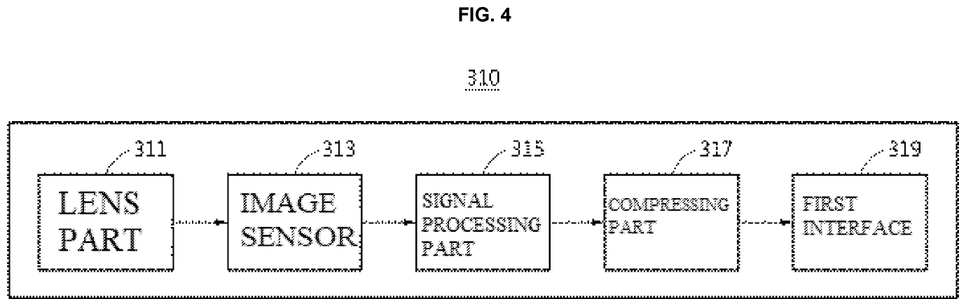

FIG. 4 is a schematic block diagram illustrating the security camera illustrated in FIG. 3.

Referring to FIG. 4, the security camera 310 may include a lens part 311, an image sensor 313, a signal processing part 315, a compressing part 317, and an interface 319.

The lens part 311 may collect light and project an image in front of the lens part 311 onto the image sensor 313 installed behind the lens part 311.

The image sensor 313 may generate an analog signal corresponding to the image projected from the lens part 311 and convert the analog signal to a digital signal. For example, the image sensor 313 may convert the analog signal to the digital signal through a low voltage complementary metal oxide semiconductor (LVCMOS), a low voltage differential signaling (LVDS), and a mobile industry processor interface (MIPI).

The signal processing part 315 may perform image signal processing on the digital signal. For example, the signal processing part 315 may perform the image signal processing such as auto exposure (AE), auto focus (AF), and auto white balance (AWB) on the digital signal.

In addition, the signal processing part 315 may convert the digital signal, on which the image signal processing is performed, to image data, for example, video format data. For example, the signal processing part 315 may convert the digital signal, on which the image signal processing is performed, to YUV video format data, wherein YUV is a color encoding system typically used as part of a color image pipeline.

The compressing part 317 may compress the image data using a standard such as moving picture experts group 4 (MPEG-4), high efficiency video coding (HEVC), and H.264, and transmit the compressed image data to the interface 319.

The interface 319 may be connected to the first wireless video bridge 330. The interface 319 may transmit the compressed image data to the first wireless video bridge 330.

The interface 319 may be an interface for Ethernet communication between the security camera 310 and the first wireless video bridge 330. The interface 319 may be electrically connected to the first wireless video bridge 330 through a network cable.

Here, the security camera 310 compresses the captured image and transmits the compressed image to the first wireless video bridge 330, but is not limited thereto, and the first wireless video bridge 330 may also compress the image data according to an embodiment.

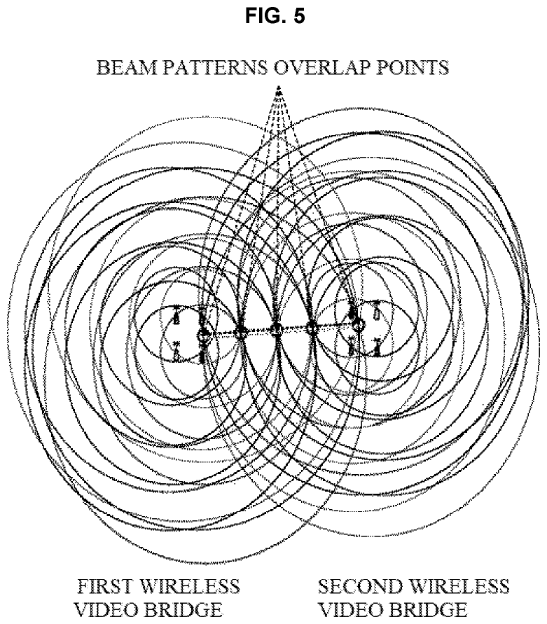

FIG. 5 is a view for describing a beamforming operation between the first wireless video bridge and the second wireless video bridge illustrated in FIG. 3.

Referring to FIG. 5, the first wireless video bridge 330 and the second wireless video bridge 410 may perform pairing and may be communicably connected. Here, the plurality of antennas of the first wireless video bridge 330 and the plurality of antennas of the second wireless video bridge 410 may form beam patterns.

The first wireless video bridge 330 may determine a direction in which the second wireless video bridge 410 is positioned with respect to the first wireless video bridge 330. Next, the first wireless video bridge 330 may amplify the beam patterns while changing directions of the beam patterns (for example, shifting phases of subcarriers) such that a direction in which points at which the beam patterns of the first wireless video bridge 330 commonly overlap are connected is toward the second wireless video bridge 410.

The second wireless video bridge 410 may also operate like the first wireless video bridge 330.

Accordingly, the beam patterns output from the first wireless video bridge 330 toward the second wireless video bridge 410 may increase, and the beam patterns output from the second wireless video bridge 410 toward the first wireless video bridge 330 may increase. Accordingly, the image data transmitted from the security camera 310 can be remotely transmitted.

The above-described device may be formed as hardware components, software components, and/or combinations of hardware and software components. For example, the device and components described in the embodiments may be formed using one or more general purpose computers such as processors, controllers, arithmetic logic units (ALU), digital signal processors, microcomputers, field programmable gate arrays (FPGA), programmable logic units (PLU), microprocessors, other devices capable of executing and responding to instructions, and special purpose computers. A processing device may perform an operating system and one or more software applications performed on the operating system. In addition, the processing device may also respond to the execution of the software to access, store, manipulate, process, and generate data. It is described that one processing device is used for the sake of convenience of the understanding, but the skilled in the art may know that the processing device may include a plurality of processing elements and/or a plurality kinds of processing elements. For example, the processing device may include a plurality of processors, or one processor and one controller. In addition, the processing device may be another processing configuration such as a parallel processor.

The software may include computer programs, codes, instructions, or combinations of one or more thereof, the processing device may be configured to operate according to wishes, and the software may also individually or collectively instruct the processing device. The software and/or data may be permanently or temporarily embodied in certain apparatuses, components, physical devices, virtual equipment, computer storage media or devices, or transmitted signal waves to be interpreted by the processing device or to provide the instructions or data to the processing device. The software may also be dispersed to, stored in, and executed by computer systems connected through a network. The software and data may be stored in one or more computer readable recording media.

The method according to the embodiment may be realized as a program instruction type method which can be performed by various computers and stored in computer readable media. The computer readable media may store program instructions, data files, data structures, and the like individually or combinations thereof. The program instructions written in the media may be instructions which are specifically designed and formed for the embodiment or may also be instructions commonly known to and used by the skilled in the computer software. Examples of the computer readable recording media include hardware devices such as magnetic media such as hard discs, floppy discs, and magnetic tapes, optical media such as compact disk read only memories (CD-ROM) and digital versatile discs (DVD), magneto-optical media such as floptical disks, ROM, random access memories (RAM), and flash memories which are specifically configured to store and execute program instructions. Examples of the program instructions include machine codes interpreted by compilers and also include high-level codes which can be executed by computers using interpreters and the like. The above-described hardware device may be configured to operate with one or more software modules for performing the operation of the embodiment and vice versa.

As described above, while the embodiments have been described with reference to specific embodiments and drawings, various modifications and alterations may be made by those skilled in the art from the above description. For example, when the described technologies are performed in orders different from the described methods, and/or the described components such as a system, a structure, a device and a circuit are coupled or combined in the form different from the described method, or replaced or substituted with other components or equivalents, the appropriate result may be achieved.

Therefore, other implementations, other embodiments and equivalents within the scope of the appended claims are included in the range of the claims to be described.

1. A wireless video bridge comprising:
an interface; and
a shielding part configured to remove a harmonic signal generated in relation to the interface when the wireless video bridge is operating.

2. The wireless video bridge of claim 1, wherein the shielding part includes at least one from among a bead, a resistor, and a capacitor.

3. The wireless video bridge of claim 1, wherein:
the interface includes a local area network (LAN) port configured to communicate with an external device outside the wireless video bridge; and
the shielding part includes a first shielding part configured to remove a harmonic signal generated by a data transmission line positioned between the LAN port and a controller of the wireless video bridge for data transmission.

4. The wireless video bridge of claim 3, wherein:
the interface further includes a switch port configured to communicate with a switch board of the wireless video bridge; and
the shielding part further includes a second shielding part configured to remove a harmonic signal generated by a connecting cable which connects the switch port and the switch board.
